(19) United States
(12) Patent Application Publication
(10) Pub. No.: US 2012/0067834 A1
(43) Pub. Date: Mar. 22, 2012

(54) Invisible Magnetic Quilt Hanger

(76) Inventor: Brian Edward Gokey, Norco, CA (US)

(21) Appl. No.: 13/301,036

(22) Filed: Nov. 21, 2011

Related U.S. Application Data
(63) Continuation-in-part of application No. 12/231,506, filed on Sep. 3, 2008.

(51) Int. Cl. A47B 81/00; H01F 7/02

(52) U.S. Cl. 211/45

(57) ABSTRACT

The objective of the invention is to enable easy installation and displaying of a quilt, textile or similar on a vertical mounting surface invisibly. It also removes the critical need for leveling devices to obtain precision horizontal installation, still allowing for proper horizontal display of the quilt. Powerful magnets, center point mounting, and variable length rod enables display and easy switching out of different sized textiles. Using an adjustable rod across the full width of the quilt ensures proper support as well as full exposure of the quilt [or viewing without the distraction of the mounting device itself being evident. Options in device mounting make it possible to remove and re-install without damaging the vertical surface on which it was mounted. No compression of the textile is used that might result in fading (evident in most textiles exposed to light) of the quilt.

### CROSS REFERENCE TO RELATED APPLICATIONS

This application is a continuation-in-part of applicant's co-pending application Ser. No. 12/231,506 filed Sep. 03, 2008 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to a magnetic quilt hanger that enables the easy mounting and displaying of a quilt, textile, or similar on a vertical surface invisibly.

2. Description of Related Art Including Information Disclosed Under 37 CFR 1.97 and 1.98.

Various types of hangers are known for displaying items such as quilts, tapestry, rugs, banners, or other decorative like items. This invention was designed to address a multitude of problems faced by users of previous quilt or textile hangers. Included are the elimination of damage to the quilt caused by compression (uneven fading, sagging), wall damage, size limitations, difficulty in installation, and the hanger distracting from the quilt itself.

A number of patents have been issued that provide some of the features identified in this document. Exemplary examples of patents that have been issued that try to address this problem are identified and discussed below.

U.S. Pat. Number 6,219,892 issued on Apr. 24, 2001 to Gwyneth K. Johnsen discloses a Display Hanger for Sheet Items of Fabric art. The fabric art is glued to an interface strip. The interface strip includes a pocket with a fixed length rod. The rod is the captured in a holder. While this patent discloses a pocket, the pocket is glued to the edge of the fabric art and does not disclose a magnet, and expandable rod or high friction coating.

U.S. Pat. No. 5,833,193 issued on Nov. 10, 1998 to Rodger Derda et al., discloses an Expandable and Adjustable Display Device. The expandable display device has a central member with opposing wings that can expand from with the central member. While this patent discloses an expandable member this patent does not disclose a pocket, a magnet, or high friction coating.

U.S. Publication Number 2008/0023605 was published on Jan. 31, 2008 to Denis Yang and discloses a Scroll Hanger. The scroll hanger allows for a thin sheet of material to be retained. The supported document must be thin because the document is squeezed on the holder with an elongated magnet. While this publication discloses magnet(s), this disclosure does not disclose a pocket, an expandable member, or high friction coating.

What is needed is a quilt holder that provides the appearance that the quilt is floating on the wall. This is accomplished by using an expandable rod that is placed in a hidden pocket and suspending the rod with magnets that level and center the quilt on the wall. The proposed invisible magnetic quilt holder provides this solution.

### BRIEF SUMMARY OF THE INVENTION

It is an objective of the invisible magnet quilt holder is to solve deficiencies existing in previously available quilt hangers. This invention provides for proper display of a quilt, textile, banner or other artwork without damaging the fabrics or the wall it is attached to, without having to be sized specifically for each quilt and without the hanger being visible. A pocket is secured to the fabric or textile. The pocket allows a fixed length or an expandable rod or bar to be inserted for support and attraction with a magnet.

The hanger will not damage the wall surface because it uses adhesive that will not remove paint or leave residue when removed. Although provision is made if a user wishes to hard-mount the hanger to the wall, it is easily installed and removed if desired without leaving any indication on the wall. The body of the hanger is a substrate that is affixed to a wall with removable adhesive means, or may be screwed into the wall if the user desires.

Since the quilt is hung using a metal rod inserted into a rod pocket (sleeve) attached to the back of the quilt, the entire quilt is supported properly and will not be subject to stretching and sagging caused by compression style quilt hangers. Additionally, the quilt fabric is not subject to uneven fading which occurs with compression style hangers.

Use of an adjustable rod within the quilt rod pocket allows for quickly changing out wall hangings without having to change the hanger to a different size. Most other available quilt hangers require being sized specifically for each quilt size or size range.

It is another objective of the invisible magnet quilt holder to be low profile thereby allowing the quilt to hang very close to the wall, and does not show at all, allowing the viewer of the art to enjoy only the artwork.

The installation of this quilt hanger does not require any tools to accomplish. It is easy for one person to do, and provides for horizontal adjustment if needed when quilt is hung. The disclosed design self-centers the quilt on the wall by use of discreet magnets that both attract a rod but also centers the rod on the magnets. The light weight magnets can be easily secured to a wall. Multiple magnetic holders can be used based upon the weight of the item that is being hung.

It is still another object of the invisible magnet quilt holder to utilize friction material on the magnet and or on the bracket materials to increase the frictional force that holds the textile, quilt or document. The use of high frictional material reduces the amount of force that is required by the magnets to retain or squeeze the pocket or the displayed product.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows the mounting substrate, the disc magnets, the adjustable metal rod, and a quilt with rod pocket showing the metal rod installed.

FIG. 2 shows an individual quilt hanger with the high friction tape adhered.

FIG. 3 shows a perspective view of the quilt holder installed on a quilt.

### DETAILED DESCRIPTION OF THE INVENTION

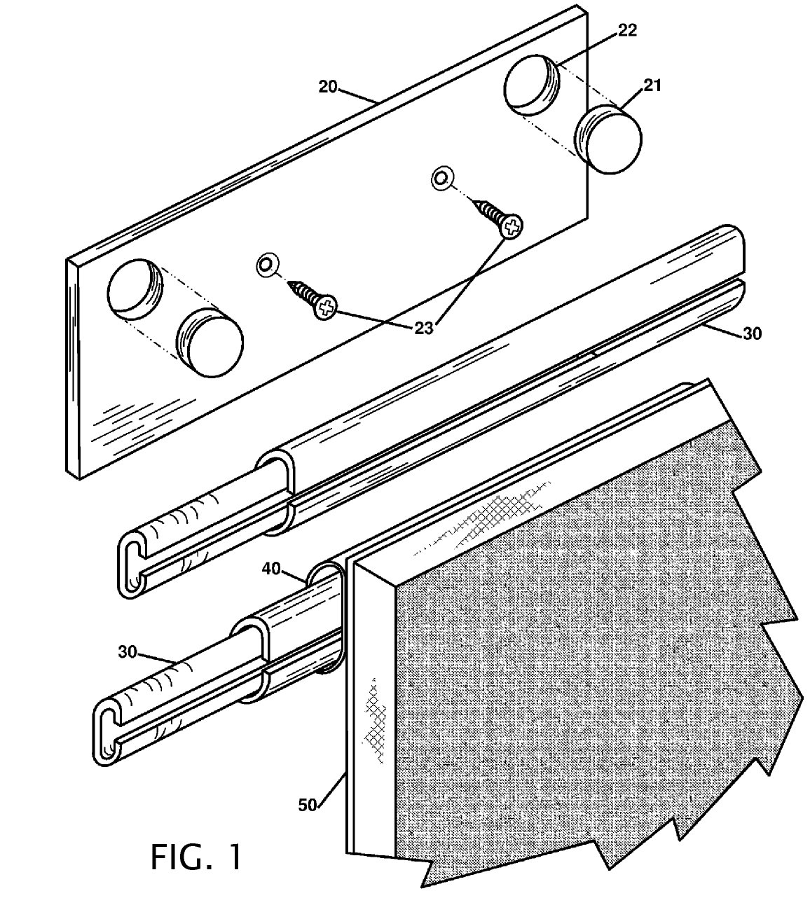

FIG. 1 shows the mounting substrate, the disc magnets, the adjustable metal rod, and a quilt with rod pocket showing the metal rod installed. The product is comprised of the following components: the mounting substrate 20. This substrate 20 will have two purposes:

It will hold or support powerful magnets 21. These magnets 21 are set into counter bores 22 and affixed if substrate is non-ferrous. If substrate 20 is of ferrous material, magnets are attached by magnetic attraction.

The substrate 20 will facilitate the mounting of this component to a vertical surface by mechanical 23 or adhesive options.

Magnets 21—The attractive force of these magnets 21 to the adjustable metal rod 30 enables sufficient support for display of the textile or quilt.

Adjustable Length Metal Rod 30. This rod 30 is used to support the textile or quilt 50 when it is installed in a rod pocket 40. The ferrous property of this metal rod 30 enables it to be attached to magnets 21 installed in the substrate 20.

The magnets 21 are mounted in or on the substrate 20. The substrate 20 is mounted on a vertical surface by mechanical 23 or adhesive options. The adjustable length metal rod 30 is installed in rod pocket of the textile or quilt 50. The rod 30 with the quilt 50 or textile is then introduced to the mounting substrate 20 in which the magnetic attraction will support and hang the quilt 50 for display.

The device also enables very fast mounting and removal of quilt 50 for show-and-tell purposes. When used as intended, this device allows for proper support of the quilt, thus reducing the risk of damage caused by sagging.

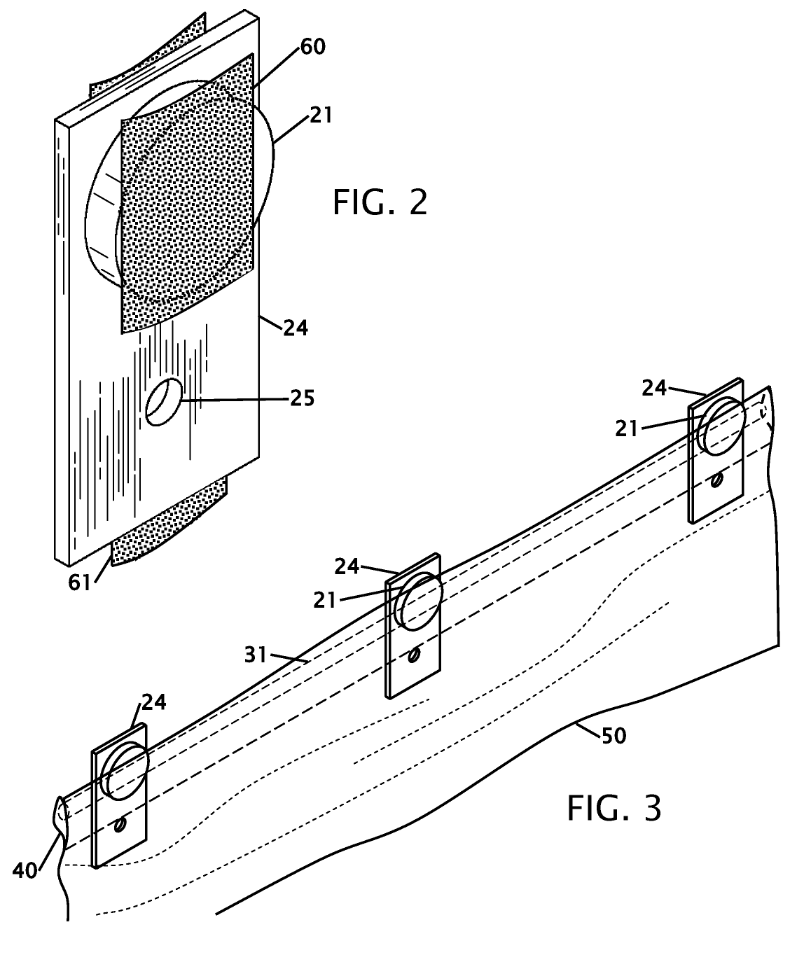

FIG. 2 shows an individual quilt hanger with the high friction tape adhered and FIG. 3 shows a perspective view of the quilt holder installed on a quilt. For many installations the weight of the pieces is difficult for an installer to handle and maintain a level installation. In this embodiment, individual hangers 24 are utilized. The number of hangers can be increased or decreased based upon the weight of the item that will be hung. The hangers 24 have a hole 25 for installation of a screw that can be easily installed into a stud within a wall. The back of the hanger may also include a high friction tape 61 that further secures the hanger onto the wall. Because these hangers 24 are individual they are ideal for installations where the stud spacing is not standard or varies.

The hanger 24 is preferably about one inch wide by two inches tall. While these dimensions are given variation from these dimensions are contemplated. The width of one inch allows two separate hangers 24 to be installed on a single stud wall where the mounting screws are installed at angles entering into a standard 2×4 stud. The hanger 24 is preferably made from a ferrous material that is attracted by a magnet 21.

The magnet 21 is preferably a rare earth magnet such as neodymium that provides a high attraction force to the hanger 21. The magnetic properties will generally hold the magnet 21 on the hanger 24 with sufficient force, but it is also contemplated that the high friction tape 60 or 61 can also be installed between the magnet 21 and the holder 24. The high friction tape has a back adhesive surface that sticks to one surface and an opposing surface with the high friction surface. In the preferred embodiment, the front surface of the magnet 21 is also covered with the high friction tape 60.

From FIG. 3, a textile or quilt 50 is shown with one or more extendable or fixed length rod(s) 31 within a pocket 40 secured to the product that is being hung. Because of the magnetic attractive force, and installer can simply lift the textile 50 with the installed rod 31 into proximity of one or more magnets 21. The attractive forces of the magnet(s) 21 will pull and hold the rod 31. As the installer brings the remainder of the rod(s) 31 in proximity to the remaining magnets 21 the rod(s) 31 will be pulled into position on the magnet(s) 21. The magnets not only attract the rod(s) 31, but also will self-center the rod(s) 31 onto the magnet(s) 21.

Thus, specific embodiments of a quilt hanger have been disclosed. It should be apparent, however, to those skilled in the art that many more modifications besides those described are possible without departing from the inventive concepts herein. The inventive subject matter, therefore, is not to be restricted except in the spirit of the appended claims.

1. A magnetic quilt hanger comprising:
at least two solid ferrous substrates having at least one magnet magnetically secured on each solid ferrous substrate;
said at least two solid ferrous substrates are separately is mountable flat to a wall using at least one fastener on each of said at least two solid ferrous substrates;
a quilt or textile having a rod pocket wherein said rod pocket is added along a horizontal length of said quilt or textile and said rod pocket is located behind said quilt or textile;
at least one ferrous rod installed within said rod pocket to completely hide said at least one ferrous rod within said rod pocket, and
said at least one ferrous rod within said rod pocket on said quilt or textile is magnetically attracted to retain said rod pocket on said at least two solid ferrous substrate to hang said rug or textile secured to said rod pocket vertically in a planar flat arrangement on said wall without compressing said quilt or textile or reducing an overall size of said quilt or textile wherein said at least two solid ferrous substrates self-center said at least one ferrous rod on each of said at least one magnet magnetically secured on each solid ferrous substrate.

2. The magnetic quilt hanger according to claim 1 wherein said least one ferrous rod has an adjustable length.

3. The magnetic quilt hanger according to claim 1 wherein each of said at least two solid ferrous substrates is fastened to said wall with at least one screw.

4. The magnetic quilt hanger according to claim 1 wherein said at least two solid ferrous substrates is mounted to said wall with an adhesive.

5. The magnetic quilt hanger as disclosed in claim 1 wherein said quilt hanger allows different width quilts or textiles to be displayed without said hanger being visible.

6. The magnetic quilt hanger according to claim 1 wherein said magnets are inserted into counter bores in said substrate.

7. The magnetic quilt hanger according to claim 1 wherein said least two solid ferrous substrates have a high friction tape applied to the back of said least two solid ferrous substrates.

8. The magnetic quilt hanger according to claim 1 wherein said least two solid ferrous substrates have a high friction tape applied to the front of said least two solid ferrous substrates.

9. The magnetic quilt hanger according to claim 1 wherein said at least one magnet has a high friction tape applied to the back of said magnet.

10. The magnetic quilt hanger according to claim 1 wherein said at least one magnet has a high friction tape applied to the front of said magnet.
